(19) United States
(12) Patent Application Publication
(10) Pub. No.: US 2011/0025005 A1
(43) Pub. Date: Feb. 3, 2011

(54) BEACH BUGGY

(76) Inventor: Tracy Howell, Venice, FL (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/510,319

(22) Filed: Jul. 28, 2009

(51) Int. Cl. B62B 7/06

(52) U.S. Cl. 280/47.24

(57) ABSTRACT

A buggy is disclosed for transporting across sandy areas such as beaches, parks and the like. The side and end walls of the buggy may be formed of a flexible and/or elastic mesh material to permit airflow through the sides and ends of the buggy. The buggy may also include oversized balloon tires that may be folded inwardly to a position adjacent the bottom of the surface. Likewise, the walls of the buggy may be folded inwardly on top of the base so that the buggy can be placed in a flatten condition for storage and transportation to the point of use.

### FIELD OF THE INVENTION

A buggy is disclosed for transporting young children with associated diapers, toys, etc. at recreational locations and particularly across sandy areas such as beaches and parks.

### BACKGROUND OF THE INVENTION

Beaches, playgrounds and parks are popular areas of recreation. Individuals desire to attend such areas and relax, swim, and/or sunbathe. However, most trips to the beach, playgrounds, etc. require preparation, for example bringing snacks, beverages and assorted equipment that make the visit more comfortable. Moreover, when a parent or other individual caring for a child or children desires to go to a recreational area the trip can be more difficult and complex to plan and enjoy. For example, extra equipment such as a diaper bag, toys, an apparatus for providing shade to a child, and the like can make carrying all needed items for a visit very challenging.

Items such as baby strollers, buggies, and the like can be used to help transport young children when the underlying surface is a sidewalk, pavement or is otherwise relatively firm. However, when visiting areas such as a beach, baby strollers and heretofore buggies do not have the capability to properly traverse the soft sand that can be present. Therefore, an improved buggy that provides the capability to transport one or more children along with necessary items across an unstable terrain would be desirable.

### SUMMARY OF THE INVENTION

A buggy is disclosed for transporting young children with associated diapers, toys, etc. at recreational locations, and particularly across sandy areas such as beaches, parks and the like. The buggy may have a base with four walls that extend vertically upward from the base to define a space for holding a small child, etc. The walls may be formed of a flexible and/or elastic mesh material to permit airflow through the sides and ends of the buggy. An umbrella may also be removably mounted to one end of the buggy to extend upwardly and over at least a portion of the buggy to provide shade to a child located in the buggy.

Wheels having oversized tires may be mounted to the base in a rolling arrangement. The tires, in addition to being oversized, may be what are known as “balloon tires” which afford for the rolling of the buggy along surfaces such as beach sand. The wheels of the buggy may also be folded inwardly to a position adjacent the underside of the base. Likewise, the walls of the buggy may be folded inwardly on top of the base so that the buggy can be folded in a flat condition for storage and/or transportation to the point of use.

A handle may also be pivotally attached to the base to permit the buggy to be pulled along the ground.

This application claims priority from U.S. Provisional Application No. 61/083,660, filed Jul. 25, 2008, the disclosure of which is incorporated by reference herein in its entirety.

### BRIEF DESCRIPTION OF THE DRAWINGS

Reference will be made herein to the associated drawings, in which like reference numbers refer to like parts throughout, and in which:

FIG. 1 is a perspective rear view of an embodiment of a buggy;

FIG. 2 is a planar view of the underside of the buggy shown in FIG. 1; and

FIG. 3 is a planar view of an end of the buggy shown in FIG. 1 showing how the walls and the tires may be collapsed or folded.

### DETAILED DESCRIPTION OF THE PREFERRED EMBODIMENTS

A buggy is disclosed for transporting young children with associated diapers, toys, etc. at recreational locations, and particularly across sandy areas such as beaches, parks and the like. The buggy may include a base and have four walls formed of a flexible and/or elastic mesh that extend vertically upward from the base. Wheels having oversized balloon tires may be mounted to the base in a rolling arrangement. The wheels and the walls of the buggy may be folded down to allow for storage and/or transportation to the point of use. A handle may also be pivotally attached to the base to permit the buggy to be pulled along the ground.

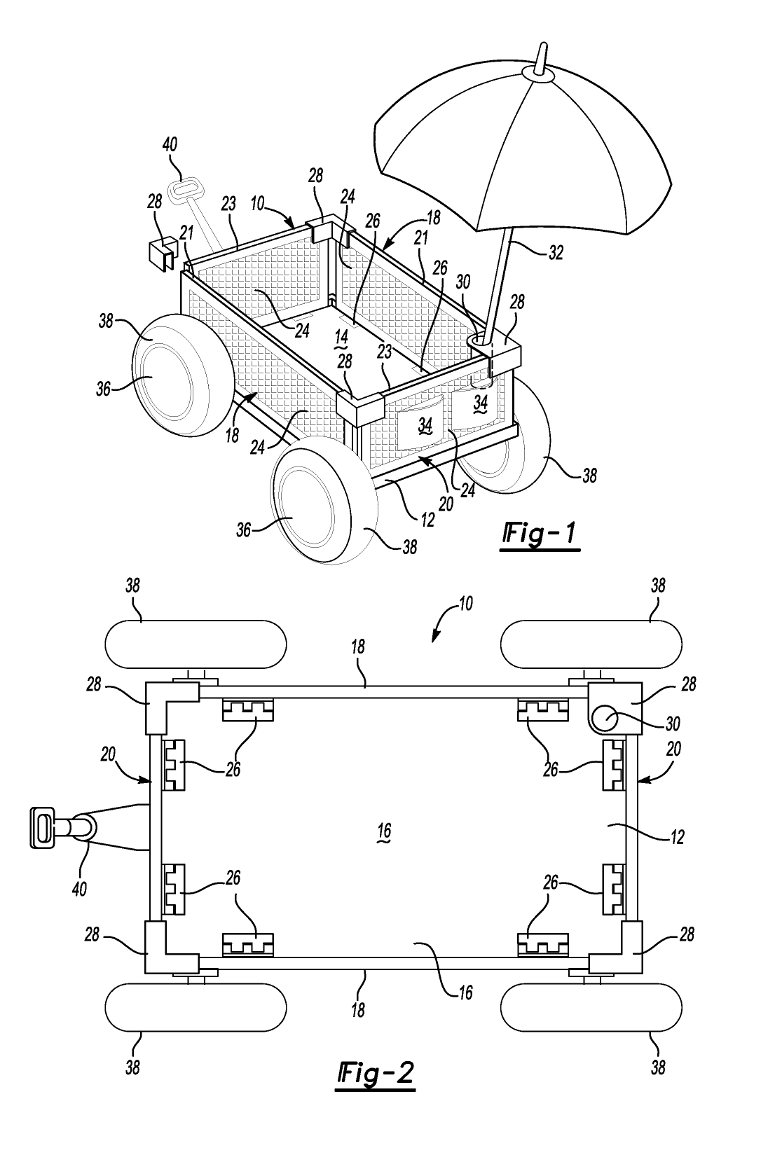

Referring now to FIGS. 1-3, a buggy 10 may have a base 12 that may include a top or upper side 14 and a bottom or lower side 16. The base 12 may be dimensioned such that at least one child can be laid upon it. It will, however, be appreciated that the base 12 may also be dimensioned such that two young children can be laid upon it.

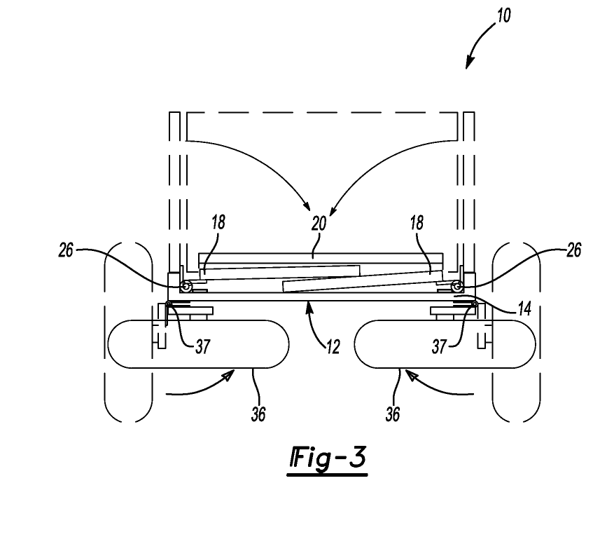

Still referring to FIGS. 1-3, and as best shown in FIG. 2, extending from the upper side 14 of the base 12 are side 18 and end 20 walls. The side 18 and end 20 walls are constructed of a frame 21, 23 and a mesh material 24. The frames 21, 23 of the side 18 and end 20 walls are mounted along their lower edges to the base 12 by hinges 26 so that they can be folded downwardly on top of the base 10 to a position shown in FIG. 3. Corner caps 28 may be provided to fit over the corners at the juncture of each side 18 and end 20 wall to maintain the walls 18, 20 in an upright position. Moreover, at least one of the corner caps 28 may be provided with a holder 30 for retaining the lower end of the post of an umbrella 32 in a position to provide shade or protection from the rain for the child (not shown) being transported in the buggy 10.

Still referring to FIGS. 1-3, the frame 21, 23 of the buggy may be constructed of polyvinylchloride (PVC). In addition, it is noted that the frame 21, 23 is illustrated in the drawings as rectangular in cross section. It could, however, be in the more common form of PVC tubing and therefore circular in cross section. Also, although the side 18 and end 20 walls are shown as including mesh material 24, it should be understood that the mesh material 24 could be replaced with a canvas either at the side 18 or the end 20 walls or both to better protect a child from the sun.

Referring now to FIG. 1, pockets 34 may be attached to at least one panel of the mesh material 24. However, it will be further appreciated that the pockets 34 may be attached to the mesh material 24 in a number of places and by any means or method known to those skilled in the art, illustratively including hook-and-loop fasteners, adhesives, buttons, snaps, sewn seams and the like. In some instances, the pockets 34 may be used to store and carry items such as diapers, bottles, sunscreen, clothing, shoes and the like.

Referring now to FIGS. 1-3, wheels 36 may be attached to the base 12 in a rolling arrangement and in a variety of different ways. In some instances, for example, the wheels 36 may be attached to a chassis that is located adjacent to the lower side 14 of the base 12. Alternatively, and as best seen in FIG. 3, the wheels 36 may be pivotally mounted to the lower side of the base 12 by hinges 37 so that they may be pivoted or folded to a compact position to permit storage and/or transportation of the buggy 10. As shown in FIGS. 1 and 2, a handle 40 can be attached to the base 12 and used to pull, push and/or steer the buggy 10.

Still referring to FIGS. 1-3, the tires 38 may be balloon tires that are oversized so that the buggy 10 may be easily rolled along surfaces such as beach sand. Suitable tires constructed of either polyurethane or a soft, pliable plastic are commercially available from WHEELEEZ®. However, other suitable inflatable or rigid balloon tire designs may be obtained from other vendors.

The foregoing drawings, discussion and description are illustrative of specific embodiments of the present invention, but they are not meant to be limitations upon the practice thereof. Numerous modifications and variations of the invention will be readily apparent to those of skill in the art in view of the teaching presented herein. It is the following claims, including all equivalents, which define the scope of the invention.

I claim:

1. A buggy comprising:
a base having a top and a bottom surface, a pair of sides and a pair of ends;
a pair of side walls and a pair of end walls, the walls extending generally vertical from the base and defining with the base a space for containing items, each wall being connected at a lower edge to the base by a hinge such that each wall is foldable toward the base;
two pairs of wheels, one pair of wheels being mounted to each side of the base in a rolling arrangement, each wheel having an oversized balloon tire; and
a handle attached to the base.

2. The buggy of claim 1, wherein each wheel is mounted to the base by a hinge such that each wheel is foldable toward the base.

3. The buggy of claim 1, wherein each wall comprises an elastic mesh material.

4. The buggy of claim 1, wherein each wall comprises a frame and a mesh material.

5. The buggy of claim 4, further comprising a plurality of corner caps with each cap fitting over a corner at a juncture of a side wall and an end wall to maintain the engaged walls in an upright position

6. The buggy of claim 5, wherein one cap of the plurality of corner caps comprises an umbrella holder.

7. A buggy comprising:
a base having a top and a bottom surface, a pair of sides and a pair of ends;
a pair of side walls and a pair of end walls, the walls extending generally vertical from the base and defining with the base a space for containing items;
two pairs of wheels, one pair mounted to each side of the base in a rolling arrangement and each wheel having an oversized balloon tire, the wheels being foldable to a position beneath the base; and
a handle attached to the base.

8. The buggy of claim 7, wherein each wall comprises an elastic mesh material.

9. The buggy of claim 7, wherein each wall comprises a frame and a mesh material.

10. The buggy of claim 9, further comprising a plurality of corner caps with each cap fitting over a corner at a juncture of a side wall and an end wall to maintain the engaged walls in an upright position

11. The buggy of claim 10, wherein one cap of the plurality of corner caps comprises an umbrella holder.

12. The buggy of claim 7, wherein each wall is connected at a lower edge to the base by a hinge such that each wall is foldable toward the top of the base.
